(19) United States
(12) Patent Application Publication
(10) Pub. No.: US 2002/0019746 A1
(43) Pub. Date: Feb. 14, 2002

(54) Aggregating persons with a select profile for further medical characterization

(76) Inventors: Hugh y. Rienhoff JR., San Carlos, CA (US); James R. Kean, Portland, OR (US)

Correspondence Address: TOWNSEND AND TOWNSEND AND CREW, TWO EMBARCADERO CENTER, EIGHTH FLOOR, SAN FRANCISCO, CA, 94111-3834, US

(21) Appl. No.: 09/808,442

(22) Filed: Mar. 13, 2001

Related U.S. Application Data
(60) Provisional application No. 60/190,359, filed on Mar. 16, 2000.
(60) Provisional application No. 60/190,360, filed on Mar. 16, 2000.

(51) Int. Cl. G06F 17/60

(52) U.S. Cl. 705/2

(57) ABSTRACT

A method for aggregating persons with a select profile for further medical studies. The method includes browsing one or more selected electronic sites directed to medical information by a user of a selected profile at a client location, which is coupled to a worldwide area network of computers comprising an Internet. The method also includes profiling user (e.g., observed) for selected area of medicine through the browsing activities at a server location that is coupled to the worldwide area network of computers. A step of inquiring about specific information (e.g., form) from user at the client through one or more inquiries from the server is also included. The method further includes inputting information about the specific information from the client that is transferred to the server location; and delivering additional information on selected area of medicine from the server location to the client. In preferred embodiments, the above steps are repeated using any two of the above steps to develop relationship with the user.

### CROSS-REFERENCE TO RELATED APPLICATIONS

This application claims priority to U.S. application Ser. Nos. 60/190,359 and 60/190,360 filed Mar. 16, 2000, the teachings of which are both incorporated herein by reference in their entirety for all purposes.

### BACKGROUND OF THE INVENTION

The present invention generally relates to identifying populations of individuals for medical or biological characterization through a worldwide network of computers. More particularly, the present invention provides a technique including a method and system for identifying individuals that collectively constitute a population. Each individual provides information (e.g., family history, lifestyle, clinical and medical history, therapies, phenotype) that is capable of being associated with additional information such as biological information from a biological sample (e.g., DNA information) from that individual. Such information can be aggregated and correlations uncovered to provide the basis for product development such as diagnostics, therapeutic selection, behavior modification, drug discovery, and the like.

In general, bioinformatics is the study and application of computer and statistical techniques to the management of biological information, including nucleic acid sequencing. The development of systems and methods to search these databases quickly, to analyze the nucleic acid sequence information, and to predict protein sequence, structure and function from DNA sequence data has become increasingly important. This is especially true for the data collected in the human genome project, which constitutes huge volumes of information. To access this data, molecular biologists and genetic researchers require advanced quantitative analyses, database comparisons tools, expert systems and computational algorithms that allow the exploration of the relationships between the stored gene sequences and phenotype.

Correlation of the genetic information stored in these databases is useful for product development such as diagnostics, therapeutic selection, behavior modification, drug discovery, and the like. Such information is of significant interest to the pharmaceutical industry to assist in the evaluation of drug efficacy, pharmacogenomics and drug resistance. To make genomic information accessible, database systems have been developed that store the genomes of many organisms. The information is stored in relational databases that can be employed to determine relationships among gene sequences within the same genome and among different genomes.

Association and comparison of the stored genetic information to other information such as phenotype is particularly important. Systems and methods are needed that enable discovery of correlations between genotypes and phenotypes, and vise versa. Moreover, systems and methods are needed that allow aggregation of individuals with unique or selected features into subgroups or populations. The present invention remedies these and other needs.

### SUMMARY OF THE INVENTION

According to the present invention, a technique for identifying populations of individuals for medical characterization through a worldwide area network of computers is provided. In an exemplary embodiment, the present invention provides systems and methods for identifying individuals that collectively constitute a population. Each individual provides information (e.g., family history, lifestyle, clinical and medical history, therapies, phenotype) that is capable of being associated with additional information such as biological information from a biological sample (e.g., DNA information) from that individual. Such information can be aggregated and correlations uncovered to provide the basis for product development such as diagnostics, therapeutic selection, behavior modification, drug discovery, and the like.

In a specific embodiment, the present invention provides a method for aggregating persons with a select profile for further medical studies. The method includes browsing one or more selected electronic sites (e.g., websites) directed to medical information by a user of a selected profile at a client location, which is coupled to a worldwide area network of computers comprising the Internet. The method also includes profiling users (e.g., observed) for a selected area of medicine through the browsing activities at a server location that is coupled to the worldwide area network of computers. A step of inquiring about specific information (e.g., form) from the user at the client through one or more inquiries from the server is also included. The method further includes inputting information about the specific information from the client that is transferred to the server location; and delivering additional information on a selected area of medicine from the server location to the client. In a preferred embodiment, the above steps are repeated using any two of the above steps to develop a relationship with the user.

In a specific embodiment, the present invention provides a system for aggregating persons with a select profile for further medical studies. The system includes a general portal server coupled to a worldwide network of computers, where the portal server comprises a first level of subject matter from a plurality of subject matter topics and a multitude of monthly users (e.g., at least 50 million). The system also has a health portal server coupled to the general portal server through the worldwide network of computers. The health portal comprises a second level of subject matter that is more specific than the first level of subject matter, the second level of subject matter being one of a plurality of health related topics. A patient aggregate server couples to the health portal through the worldwide network of computers, where the patent aggregate server comprises a third level of subject matter that is more specific than the second level of subject matter.

In a specific embodiment, the present invention also includes the extension of collecting biological samples (e.g., blood samples) from individuals aggregated in this way. These samples may be queried in a variety of ways (e.g., interrogating genetic markers) and the results integrated with other information provided by the individual.

Numerous advantages are achieved by way of the present invention over conventional techniques. In one aspect, the invention can be used to provide a select group of people with specific or desirable characteristics for a clinical trial for a pharmaceutical or drug product or medical procedure. The invention can be implemented using conventional hardware and software techniques. In still further aspects, the invention can be used to discover diagnostic and prognostic procedures. In other embodiments, the invention can be used to discover or improve patient treatment using therapeutics and/or drugs and/or vaccines. Depending upon the embodiment, one or more of the advantages are achieved.

These and other embodiments of the present invention, as well as its advantages and features, are described in more detail in conjunction with the figures and text below.

### BRIEF DESCRIPTION OF THE DRAWINGS

FIG. 1 illustrates a representative flowchart of simplified process steps in an embodiment according to the present invention.

FIG. 2 illustrates a representative flowchart of simplified process steps in an embodiment according to the present invention.

FIG. 3 illustrates a representative flowchart of simplified process steps in an embodiment according to the present invention.

FIG. 4 illustrates a representative flowchart of simplified process steps in an embodiment according to the present invention.

FIG. 5 is a simplified overall system diagram according to an embodiment of the present invention.

### DETAILED DESCRIPTION OF THE INVENTION AND PREFERRED EMBODIMENTS

I. Definitions

Phenotype: This term is defined by any observable or measurable parameter, either at a macroscopic or system level (e.g., hair color, hair pattern, organ function, age, ethic origin, weight, level of fat, and the like) or microscopic or even cellular or molecular level, (e.g., organ function, cellular organization, mRNA, intermediary metabolites, and the like). Phenotype can also be defined as a behavior pattern, sleep pattern, anger, hunger, athletic ability. There can be many other types of phenotypes, depending upon the application, which should not unduly limit the scope of the claims herein.

Genotype: This term refers to a specific genetic composition of a specific individual organism, for example, whether an individual organism has one or more specific genetic variants up to all the variations in that individual's genome, for example, whether the individual is a carrier of a sickle cell anemia genetic variant and other genetic variations that influence the disease. The example is merely illustrative and is not intended to limit the invention defined by the scope of the claims herein.

The present invention provides, inter alia, methods and systems for identifying individuals from a population of aggregated individual profiles through a worldwide network of computers. The present invention involves individual users accessing a website. The website offers information on health-related issues and a variety of diseases and medical conditions. The individual users can learn more about these diseases and medical conditions through browsing activities on the website. The website is a trusted provider and leading brand of medical genetic information for patients, their families, physicians and pharmaceutical companies. In other aspects, the website becomes part of a Web-based community of disease-specific information, wherein a network of physicians, genetic researchers, educators, nurses and counselors are gathered for a network of high value offerings of the site.

In addition, techniques are described herein for identifying populations of individuals for medical characterization through a worldwide area network of computers. In an exemplary embodiment, the present invention provides a method for identifying populations of individuals, which can each provide information (e.g., family history, lifestyle, clinical and medical history, therapies, phenotype, and the like) that is capable of being associated with additional information such as biological information from a biological sample (e.g., DNA information) from that individual. Such information can be aggregated and correlations uncovered to provide the basis for product development such as diagnostics, therapeutic selection, behavior modification, drug discovery, and the like.

II. User's Select Profile

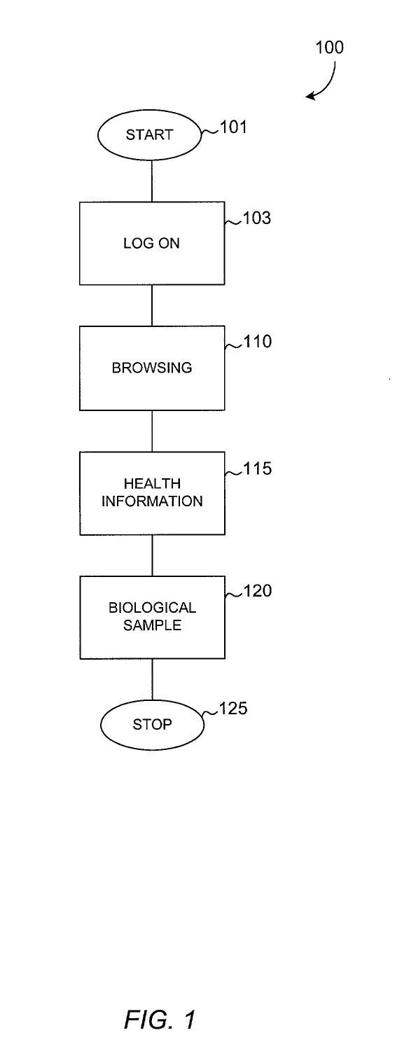

FIG. 1 is a simplified flow diagram 100 for generating a user's profile according to an embodiment of the present invention. A profile can be used in the methods and systems for identifying individuals that collectively constitute a population. This diagram is merely an example, which should not unduly limit the scope of the claims herein. One of ordinary skill in the art would recognize many other variations, alternatives, and modifications.

A. Browsing Activities

In certain aspects, a user's profile 100 can be generated by logging on 103 and browsing activities 110. Preferably, browsing activities can engender trust with the website, through the supply of trustworthy medical information to the user. To enter on this trust continuum, a user will log on to the website 103, obtain information from the website, and eventually enter health information 115 (e.g., a medical history, family background) at the website. Further inquiries can be made in order to provide additional medical information and/or to provide a biological sample 120 for further characterization. The submission of medical information 115 and a biological sample 120 to the website for further characterization amounts to the individual user having a high degree of trust for the website.

The website contains information on and hyperlinks to a variety of diseases and medical conditions. Examples of diseases and medical conditions on the website can include, but are not limited to, Alzheimer's disease, asthma, autism, breast cancer, cardiac arrest, colon cancer, coronary heart disease, Crohn's disease, Diabetes (type I), Diabetes (type II), Eating Disorders (e.g., bulimia, anorexia nervosa), epilepsy, hearing loss, long QT syndrome, lupus, multiple sclerosis, obesity, Parkinson's disease, prostate cancer, psoriasis, rheumatoid arthritis, and scleredema. The information can be stored on a database that includes, but is not limited to, a series of well-written articles and educational materials as well as news items. In certain embodiments, the website contains fields for diseases and conditions that are linked to a page(s) on the respective disease or condition.

In preferred embodiments, the user profiles, which can include phenotypic assay, genetic assay information and combinations thereof, can be aggregated with other user profiles and information to populate a database. This database can be mined in a confidential and proprietary relationship with the website. In other embodiments, third parties (e.g., research institutions, pharmaceutical companies, and the like) provide a user with information that is relevant to their profiles and areas of interest.

B. Health History Queries

In certain aspects, the user profile is prepared or augmented using links that exist on one or more pages of the website requesting that users submit their health histories. This permits the aggregation of medical profiles that are stored on a database when a plurality of users submit their health profiles.

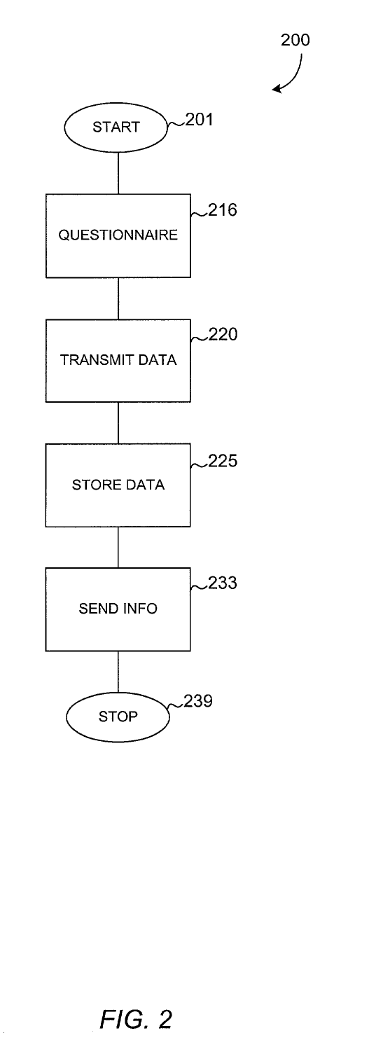

FIG. 2 is a simplified flow diagram 200 for generating the health history according to an embodiment of the present invention. This diagram is merely an example, which should not unduly limit the scope of the claims herein. One of ordinary skill in the art would recognize many other variations, alternatives, and modifications.

As a user's trust of the website increases, or if interest is strong enough, the user can access a link to a questionnaire 216 that will query them on their medical history. The user then transmits 220 the information on the survey to the website over a worldwide web of computers. The website can store 225 this health information data on a database. In some embodiments, the user will log on and register with the site by providing identification information which can include, but is not limited to, name, address, date of birth, social security number, and a password of the user's choosing. The user can be informed that by the submission of the information, that they are authorizing the website to store this information 225 including information on medical history, medications, and family's medical history. The user can revoke this consent and withdraw at any time. The user will also be informed that the website will not disclose information that would identify them to a third party or permit contact by a third party without the user's permission. By providing information on the questionnaire the user is providing consent to the website to send to the user (e.g., via a worldwide web of computers) further health information 233 for example, health related topics, opportunities to participate in clinical trials with third parties, treatment opportunities, opportunities to participate in clinical or biological research, and opportunities to provide additional information to third parties.

The queries on the questionnaire can include, but are not limited to, date of birth, sex, ethnicity, native language, and diseases and conditions (e.g., Alzheimer's disease, asthma, autism, breast cancer, cardiac arrest, colon cancer, coronary heart disease, Crohn's disease, Diabetes (type I), Diabetes (type II), Eating Disorders (e.g., bulimia, anorexia nervosa), epilepsy, hyperthyroidism, hearing loss, long QT syndrome, lupus, migraine, multiple sclerosis, obesity, Parkinson's disease, prostate cancer, psoriasis, rheumatoid arthritis, ventricular tachycardia and scleredema) that the user or user's blood relatives, (mother, father, daughter, uncle, and the like) have been diagnosed by a physician. The queries can also include entries for such items as blood pressure, cholesterol levels, medications, sensitivities to medications, history of drug or alcohol abuse, trauma, weight, and surgical procedures (e.g., heart surgery, kidney removal, gall bladder removal, and the like).

Once transmitted 220 by the user (e.g., over a worldwide web of computers), this information can be aggregated with other users' profiles in a database when the user transmits the information over a worldwide web of computers to the website. This database can be screened with a variety of filters or algorithms to identify subpopulations of the aggregated profiles. For example, the database can be queried with an algorithm that asks for a particular responses on the questionnaire that are consistent with a particular disease or condition, or profile that is of interest to a third party (e.g., an educational institute, research organization pharmaceutical company, and the like). Alternatively, the information contained in the users' profiles (aggregated health information) can be transmitted to a third party.

In certain aspects, the website queries the user to provide more detailed information, in addition to the general health profile, that is relevant to a particular disease or condition. In some embodiments, the particular disease or condition is identified by using an algorithm or filter that analyzes the aggregated health information database for profiles that meet particular criteria or a closeness-of-fit with predetermined parameters.

The users can also interact with the website and develop a relationship with the website that will engender trust of the information on the website and of the website itself. This trust can be manifested by repeat visits to the website and/or increasing amounts of time spent interacting with the website. If the trust level is high enough with the website, users can submit their health histories and/or possibly biological material. In some embodiments, individuals may submit their health profiles or biological material after 1 or more visits to the website. In other embodiments, individuals may require more than 10 visits to the website before enough trust is engendered to submit health profiles and/or biological material to the website.

Optionally, the website queries for information that is pertinent to the further classification of the user by querying about specific disease(s). These additional queries can also include, but are not limited to, asking the user to indicate if they are under a physician's care for a particular disease and if they are currently taking medications used to control or treat the indicated disease or condition. For example, an algorithm asks the database to identify users that are in generally good health, except for the existence of high blood pressure. Such users could then be asked to provide more detailed information that is relevant to cardiac disease to identify populations of the users that could benefit from new pharmaceuticals targeting high blood pressure, and/or could benefit from information or enrollment in a clinical trial on high blood pressure. Such high blood pressure subpopulations can also be candidates for genetic studies of hypertension and cardiac disease. Alternatively, for example, if analysis of the aggregated health information database by an algorithm that searches for criteria that indicate that the person is likely to suffer from asthma, then the website can ask the user to provide further information that is relevant to asthma. In the case of asthma, relevant queries can include questions or entries for smoking, wheezing, birth weight, coughing, short of breath, hay fever, allergic, skin test to test for allergies, results of a breathing test for asthma (e.g., the FEV1—the first expiratory volume), other lung problems, or whether the user is currently taking any medication such as Albuterol, Proventil, Ventolin, Serevent, Theo-dur, Unidur, Slo-bid, Intal, Tilade, Singulair, Accolate, Zyflo, Beclovent, Vanceril, Aerobid, Pulmicort, Flovent, Azmacort.

The answers to these additional inquires of the user are then transmitted 220 by the user over a worldwide web of computers to a website, where the information is stored. This database includes data embodying the information from a general health information survey taken for that user. In this manner, a database is populated with additional health information from the user. This health information is termed phenotypic information.

C. Biological Samples

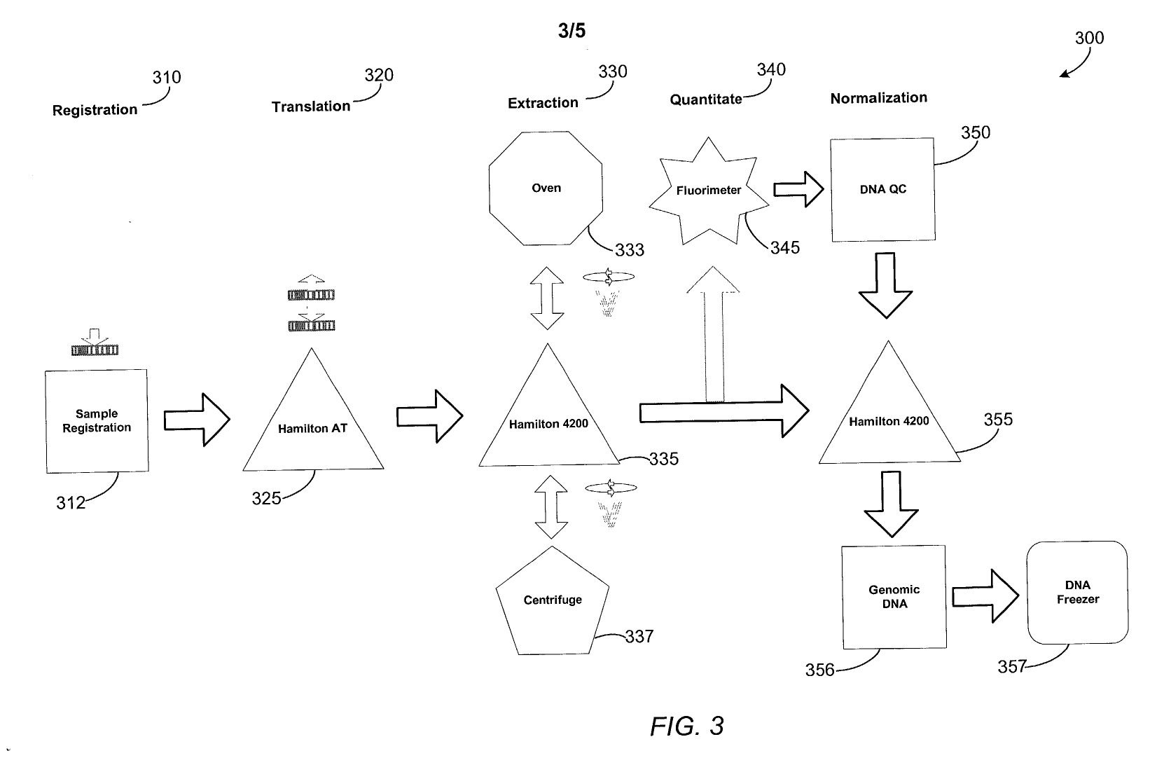

FIG. 3 is a simplified flow diagram 300 for obtaining a biological sample from a user according to an embodiment of the present invention. This diagram is merely an example, which should not unduly limit the scope of the claims herein. One of ordinary skill in the art would recognize many other variations, alternatives, and modifications.

In certain aspects of the present invention, users provide a biological sample for analysis. The analysis can then be used to profile the individual or augment the user's profile. An individual's biological sample can include, but is not limited to, blood, serum, saliva, a cheek scraping, cells, hair, skin, biopsy material (e.g., of a tumor, organ, tissue, and the like), urine, stool, and the like. In certain aspects, the biological sample is analyzed for the presence and nature (e.g., chemical structure) of a variety of biomolecules (e.g., proteins, peptides, carbohydrates, cholesterol, RNA, DNA, nucleic acids, mitochondria DNA, and the like). Of particular interest are biomolecules that are important markers or indicators for disease diagnosis or prognosis. Biomolecules will typically be analyzed to provide phenotypic or genetic information through biochemical assays.

In certain embodiments, the process of preparing a user's profile begins with registration 310. Registration 310 embodies the process of receiving a biological sample such as blood, or DNA sample(s), in an individual tube with an external sample ID, either in the form of a barcode or another annotation (handwritten, typed, and the like) attached to the individual tube. This ID is entered into a database and the sample is associated with other information (disease status, drug therapy, phenotype, behavior, family history, and the like) that is received concurrently or has already been received in an electronic format and is entered into a database. Preferably, an internal barcode ID is attached to each sample 312 after the sample is entered into the database. The registration step is typically achieved at a computer workstation with a barcode reader and a barcode printer, and preferably, in a networked environment.

In this embodiment, profile generation then proceeds to the next step or the translation step 320. Translation 320 is the step whereby an individual sample, such as blood or DNA, is added to an array of multiple samples, e.g., an array of up to 96 samples, in an 8×12 array. This “plate” of samples is then given a unique ID, whereby any single sample is then associated with both the plate and a particular coordinate within the plate (e.g., well B3). This can be achieved automatically such as by a Hamilton AT2 robot 325 integrated with a barcode reader.

Extraction 330 is typically the next step in polymorphic profile determination. Extraction 330 is the step whereby reagents are added to the blood samples to disrupt the cells, and remove the proteins, sugars, salts, RNA, and the like The resulting product is purified DNA. In certain instances, the sample received in the registration step 310 is already purified DNA, instead of a raw sample (e.g., blood sample), thus the extraction step 330 is omitted. In a preferred embodiment, the extraction step 330 is done automatically using robotic armature such as with a Hamilton 4200 MPH-8 robot 335 for reagent addition steps, an oven for incubation steps 333, and a centrifuge for purification steps 337.

In certain aspects, the next step in determining an individual's polymorphic profile is a quantitation step 340. In this process step, the concentration and purity of DNA for a particular sample is measured. This can be achieved by a variety of methods, including, but not limited to, absorbance at 260 and 280 nm or by fluorescence measurement of DNA-binding dyes. Quantitation can be accomplished using various analytical instrumentation such as a spectrophotometer (for absorbance readings) or a fluorometer 345 (for fluorescence readings).

Following quantitation 340, in certain aspects in the determination of a profile, the next step is normalization 350. In the normalization step 350, samples are diluted with a buffer to a standard concentration. After the extraction process, the samples have various concentrations, often between the range of 5-40 ng/μL. Samples will all be normalized to a concentration of approximately 10 ng/μL (+/−20%), except for samples below a threshold, which will be re-queued to repeat the above process. This step can be done on a Packard Multiprobe robot 355. Thereafter, the genomic DNA sample 356 is placed in a freezer 357 to ensure sample stability. The presence or absence of various alleles predisposing an individual to a disease is determined. Results of these tests and interpretive information are returned to a health care provider for communication to the tested individual. Diagnostic laboratories can perform such diagnoses, or, alternatively, diagnostic kits are manufactured and sold to health care providers or to private individuals for self-diagnosis.

a) Phenotypic Assays of Biological Samples

A biological sample 120 can be assayed for a variety of phenotypic characteristics and disease indicators. For example, blood can be analyzed for hemoglobin content, glycosylated hemoglobin (a diabetes marker), total cholesterol, HDL cholesterol, LDL cholesterol, white blood cell count, blood urea nitrogen, alkaline phosphatase, serum creatine, white blood cell make-up (e.g., T-cell content, macrophage content, and the like), bilirubin, SGOT(AST) (serum glutamic-oxaloacetic transaminase), SGPT (ALT) (serum glutamic-pyruvic transminase), hematocrit, red blood cell count, albumin, total protein, glucose, calcium, inorganic phosphate, potassium, sodium, uric acid, and the presence of antibodies against a particular protein (e.g., anti-HIV antibodies, anti-gp120 antibodies, and the like). Urine can be analyzed for a variety of parameters, including, but not limited to, specific gravity, pH, glucose, total protein, hemoglobin, and the presence of a particular protein. If the biological sample is a biopsy from a tumor, then the tumor can be analyzed for the presence of cells whose morphology or biomolecule makeup (e.g., BRCA1 for breast cancer) is consistent with a metastatic or cancerous state. Those of skill in the art will recognized a plethora of clinical markers and biomolecules and methods for determining their presence and content. In addition, the biological sample can be analyzed for the presence, identity, or nature of an infective entity (e.g., bacteria, virus, prion, fungus, parasite, and the like).

A biological sample can be analyzed using methods and assays that are known in the art. Examples of methods include, but are not limited to, mass spectrometry, immunoassays, radiometric assays, electrochemical assays, spectrophotometric assays, chromatographic assays, and the like. In some embodiments of the invention, methods that permit high-throughput analysis such as solid phase assays (e.g., analytical reagents immobilized on a solid surface or substrate, and the like), immunoassays and enzymatic assays are used to analyze the biological samples.

The results of such assays can be embodied in a data set and entered or transmitted to a database that contain other users' profiles. The database can contain data for the health history and phenotypic assay results of one or more users. In certain aspects, data is collected from a temporal series of samples used to construct a temporal data profile of parameters being assayed (e.g., total cholesterol, HDL cholesterol, LDL cholesterol, and the like) in order to detect changes over time that may be relevant to the classification of the user in a particular subpopulation.

In some cases, the determination of the structure of a biomolecule's phenotype can provide information as to the genotype. For example, it may be possible through immunoassays or protein characterization (e.g., mass spectrometry, amino acid sequencing, and the like) to infer what the genetic makeup was that gave rise to that particular protein sequence.

The data resulting from a phenotypic assay of an individual can be aggregated with the results of phenotypic assays from other individuals. In some embodiments, the phenotypic assay data can be used to further populate the user's profile database.

b) Genotype Assays of Biological Samples

The genotype of a user can be determined from a biological sample 120 through the analysis of the user's nucleic acids. In some embodiments, the genotype of an infective entity (e.g., bacteria, virus, prion, fungus, parasite, and the like) in a biological sample (e.g., from a subject infected with a pathogenic virus) can also be assayed. The analysis of a user's genotype and their genetic polymorphisms can be critical in the diagnosis and/or treatment of a disease and for the discovery of previously unknown genes or gene defects that give rise to a particular pathology.

Genetic polymorphisms such as restriction fragment length polymorphisms (RFLPs), short tandem repeats (STRs), variable number tandem repeats (VNTRs), and single nucleotide polymorphisms (SNPs) are known in the art. These polymorphism can give rise to defects in the expression or function of a gene and its related product which can contribute in whole, or in part, to the manifestation of a disease, syndrome or condition. There are many SNP's that are known in the art (see Table I in WO 93/452,633) and many are available on the worldwide web. For example as of Aug. 21, 2000, the SNP consortium, had 296,990 SNPs mapped to the human genome (see http://snp.cshl.org/ and http://snp.cshl.org/db/snp/map).

In some cases diseases or conditions already have genetic markers or defects in particular genes/loci that have been implicated, at least in part, in giving rise to the disease or condition (see Table I in WO 93/452,633). In the case of breast cancer, for example, variations in genes such as BRCA1 and BRCA2 have been implicated as important predictors of the risk of contracting breast cancer. For diabetes, polymorphisms in genes such as insulin, the insulin receptor, NIDDM1, NIDDM2, NIDDM3, HNF4A, GLUT4, NEUROD1, MAPK8IP1 (Mitogen-Activated Protein Kinase 8-Interacting Protein 1), and mitochondrial tRNA-Leu have been shown to be important components for the manifestation of the disease. For Long QT syndrome, genetic variations in genes for KVLQT1 (LQT1), HERG (LQT2), SCN5A (LQT3), LQT4, KCNE1 (LQT5), and KCNE2 (LQT6) have been thought to be important diagnostic indicators. Also, variations in genes for presenilin 1, presenilin 2, and beta amyloid precursor have been linked to the early-onset of Alzheimer's disease. Other variations in genes such as apo lipoprotein E and alpha-2 macroglobulin have been thought to be linked to late-onset Alzheimer's disease. Additionally, genetic variations in the APC (Adenomatous Polyposis of the Colon) gene have been implicated in the manifestation of familial adenomatous polyposis (FAP), an inherited form of colorectal cancer. Subjects suffering from another form of inherited form of colorectal cancer, non-polyposis colon cancer (HNPCC) have exhibited genetic polymorphisms in genes such as hMSH2, hMLH1, hPMS1, and hPMS2. The foregoing is not an exhaustive list of diseases and conditions and examples of genes and loci that are important for the diagnosis and prediction of developing the associated pathologies. Those of skill in the art will recognize a wide variety of other diseases and conditions as well as genetic variations that are thought to give rise to a particular disease(s).

Assays for analyzing genetic polymorphisms and analyzing nucleic acid sequences are well known in the art (see e.g., U.S. Ser. No. 09/452,633 filed Dec. 1, 1999 and Current Protocols in Molecular Biology (Ausubel et al., eds., 1994)). In general, these assays involve contacting a nucleic acid with a biochemical reagent(s) to produce a signal that renders information about the structure of the nucleic acid. Methods such as DNA sequencing, gel electrophoresis, PCR, RT-PCR, amplification methods, gene chips, and the like, can be used alone or in combination to provide genetic information. In some embodiments of the invention, methods that permit high-throughput analysis such as nucleic acid amplification methods (e.g., PCR, RT-PCR, and the like), gene chips, protein chips, immunoassays and enzymatic assays.

The results of these genetic assays can be embodied in a data set and transmitted or entered into a database than can also contain health and phenotypic data on one or more individuals. Through the use of algorithms and filters, links between genetic variations at one or more loci can be correlated with the incidence or prevalence of a particular disease or condition. Thus, in some embodiments of the invention, links between genetic variations and disease states can be uncovered.

D. Data Analysis

Using the profile data, it is possible to generate comparisons and associations between phenotypic data and genotypic data, amongst phenotypic data, amongst genotypic data and any combination thereof. For example, the user information directed to the phenotype information and the information contained in the biological sample (e.g., protein levels (e.g., quantification), RNA levels, DNA variations (e.g., single nucleotide polymorphisms and mutations)) in the database is stored and aggregated. The aggregated information can be queried using various algorithms and useful correlations are obtained.

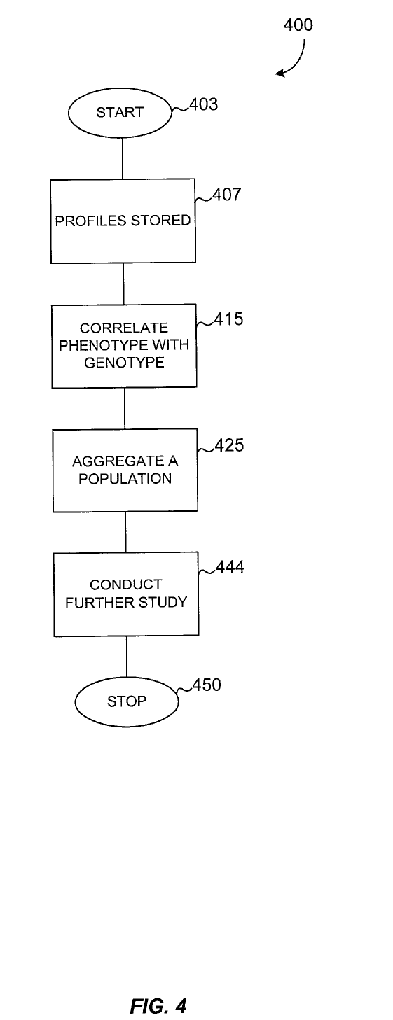

FIG. 4 is a simplified flow diagram 400 for analyzing data to an embodiment of the present invention. This diagram is merely an example, which should not unduly limit the scope of the claims herein. One of ordinary skill in the art would recognize many other variations, alternatives, and modifications.

FIG. 4 depicts an embodiment of a flow diagram that identifies correlations and association of the profiled data. The profiles from a multitude of users are stored 407 in the various relational databases. In certain instances, the profiles include genotypic information as well. Using various algorithms, it is possible to find correlations between genotypes and phenotypes 415 of select individuals. Correlation algorithms include, but are not limited to, general liner models, non-linear regressions, analysis of variance, fuzzy logic, neural networks, maximum likelihood techniques, contingency table analysis or tests, commercial algorithms and statistics. It is possible to find useful patterns between the user's profile directed to the phenotype information with the information contained in the biological sample (e.g., protein levels, RNA level variations, DNA variations) to identify trends, patterns, linkages, associations, subgroups, in the data. This database can be analyzed to achieve many different objectives.

For example, if a profile(s) meets a predetermined closeness-of-fit that the user is a good candidate for a certain drug, then the information on the location and nature of clinical trials that are relevant to the user's profile is flagged. This groups is thereafter aggregated 425 into a population. The clinical trials are drawn from a directory of entities that carry out clinical trials (e.g., pharmaceutical companies, research institutions, government institutions, universities, physicians, and the like) who may have endorsed the website and have passed stringent criteria for carrying out trials under GCP (good clinical practice) guidelines as well as applicable governmental (e.g., FDA, and the like), state, and federal regulations and laws. The aggregated group can then be contacted for additional study 444.

In another example, a correlation 415 between a genetic variation and a disease is uncovered through the analysis of the aggregated genetic and/or phenotypic database 425. Such links can be uncovered by analyzing the genotype in relationship to the phenotypic assay or disease manifestation. Through such techniques as genetic linkage analysis, chromosome walking, SNP mapping, polymorphism mapping, and the like, it is possible to determine what genetic variations in a user's genome gives rise to a particular disease or condition. The aggregation and analysis of user's genetic and/or phenotypic profiles are especially useful in determining such links.

In yet another embodiment, candidates are selected for clinical trials through the use of algorithms that select potential clinical trial candidates through criteria embodied in an algorithm for certain genetic and or phenotypic criteria. For example, if a certain genotype is linked to a bad side effect for a particular test pharmaceutical, those individual are selected out of the clinical trial. In other embodiments, the analysis provides information on the best course of treatment for a particular aggregated group 425 or drug regimen based on analysis of the data.

The aggregated group can be contacted for additonal study or information 444. For instance, clinical trials are conducted during the regulatory process to gain approval by a pharmaceutical regulatory agency (e.g., FDA) or after approval for marketing or further study. In an initial stage, such trials involve administering experimental drugs to humans on a small number of healthy volunteers to determine the safety, side effects, dosage levels, mechanism of action, and pharmacokinetics, and the like, of the experimental drug (e.g., Phase I trials). If the experimental drug passes the Phase I trial stage, a Phase II trial is typically conducted. A Phase II clinical study involves a larger patient population such as an aggregated group 425, and is primarily directed at determining whether the experimental drug is effective at treating the indication(s) being analyzed in the trial. Phase II trials also involve looking at the side effects, adverse events, and safety profiles of the drug. In a Phase III study, the drug is typically tested on a larger sample group than the Phase II trial (e.g., hundreds to thousands of patients). Phase III trials provide a more extensive and in-depth picture of the safety, effectiveness, benefits, adverse event profile, and the like of the particular experimental drug. Post-approval trials, such as latter stage Phase III or Phase IV studies, can be used to compare one or more indices such as the safety, effectiveness, health benefits, cost benefits, long-term effectiveness with another pharmaceutical used to treat the same or similar indication.

III. Network System

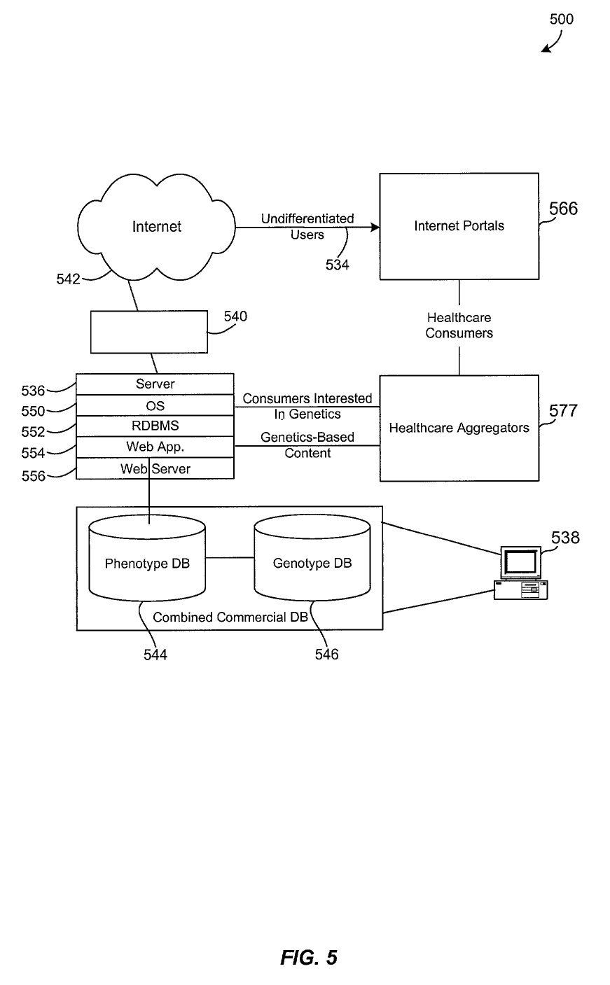

FIG. 5 is a simplified overall system diagram 500 according to an embodiment of the present invention. This system is merely an example, which should not unduly limit the scope of the claims herein. One of ordinary skill in the art would recognize any other variations, alternatives, and modifications.

FIG. 5 depicts a network system 500 suitable for storing and retrieving information in databases (e.g., relational) of the present invention. Network 500 includes a network cable 534 to which a network server 536 and a client 538 are connected. Cable 534 is also connected to a firewall/gateway 540, which is in turn connected to the Internet 542.

Network 500 can be any one of a number of conventional network systems, including a local area network (LAN) or a wide area network (WAN), as is known in the art (e.g., using Ethernet, IBM Token Ring, wireless, satellite or the like). Network 500 includes functionality for packaging client calls in a well-known format (e.g., URL) together with any parameter information into a format (of one or more packets) suitable for transmission across a cable or wire 534, for delivery to database server 536.

Server 536 includes the hardware necessary for running software to (1) access database data for processing user requests, and (2) provide an interface for serving information to client machine 538. In a preferred embodiment, depicted in FIG. 5, the software running on the server machine supports the World Wide Web protocol for providing page data between a server and client.

Client/server environments, database servers, and networks are well documented in the technical, trade, and patent literature. The concepts of “client” and “server,” as used in this application and the industry, are very loosely defined and, in fact, are not fixed with respect to machines or software processes executing on the machines. Typically, a server is a machine or process that is providing information to another machine or process, i.e., the “client,” that requests the information. In this respect, a computer or process can be acting as a client at one point in time (because it is requesting information) and can be acting as a server at another point in time (because it is providing information). Some computers are consistently referred to as “servers” because they usually act as a repository for a large amount of information that is often requested. For example, a Website is often hosted by a server computer with a large storage capacity, high-speed processor and Internet link having the ability to handle many high-bandwidth communication lines.

As shown, server 536 includes an operating system 550 (e.g., UNIX) on which runs a relational database management system 552, a World Wide Web application 554, and a World Wide Web server 556. The software on server 536 may assume numerous configurations. For example, it may be provided on a single machine or distributed over multiple machines.

World Wide Web application 554 includes the executable code necessary for generation of database language statements (e.g., SQL statements). Generally, the executables will include embedded SQL statements. In addition, application 554 includes a configuration file which contains pointers and addresses to the various software entities that comprise the server as well as the various databases which can be accessed to service user requests. Configuration file also directs requests for server resources to the appropriate hardware, as may be necessary should the server be distributed over two or more separate computers.

Client 538 includes a World Wide Web browser (e.g., Microsoft® Explorer) for providing a user interface to server 536. Through the Web browser, client 538 transmits information from questioners to phenotype database 544. Genotypes derived from the submitted biological samples are used to populate genotype database 546. Thus, the user will typically point and click to user interface elements such as buttons, pull down menus, scroll bars, and the like conventionally employed in graphical user interfaces. After the health histories and other profile information are generated, the user's Web browser transmits the information to Web application 554 which formats them to produce the pertinent information to be stored in phenotype database 544.

In one embodiment, the World Wide Web server component of server 536 provides Hypertext Mark-up Language documents (“HTML pages”) to a client machine. At the client machine 538, the HTML document provides a user interface, which is employed by a user to formulate his or her transmission to database 544. That transmission is converted by the Web application component of server 536 to a SQL storage code. That transmission is used by the database management system component of server 536 to store data in database 544 and provide that data to server 536 in an appropriate format when requested.

When network 500 employs a World Wide Web server and clients, it preferably supports a TCP/IP protocol. Local networks such as this are sometimes referred to as “Intranets.” An advantage of such Intranets is that they allow easy communication with public domain databases residing on the World Wide Web (e.g., the GenBank World Wide Website). Thus, in a particular preferred embodiment of the present invention, client 538 can directly access data (via Hypertext links for example) residing on Internet databases using a HTML interface provided by Web browsers and Web server 556. The databases remain private using firewall 540 to preserve in confidence the contents of database 544 and database 546.

In certain preferred embodiments, databases 544 and 546 are relational databases. As such, all files, all records and all data fields are interrelated with one another. In fact, all files, records and data fields in the profiles, are instantaneously accessible, identifiable and expandable. One can request the system to make recommendations in a multitude of data fields throughout the database, and the system will automatically link all the files and make the appropriate queries.

In a preferred embodiment, the present invention provides a networked system for aggregating persons with a select profile for further medical studies. The system includes a general portal server 566 coupled to a worldwide network of computers, where the portal server 566 comprises a first level of subject matter from a plurality of subject matter topics and a multitude of monthly users. The monthly users are typically about a 1 million, more preferably about 1 million to about 20 million, and most preferably, about 1 million to about 50 million. In one embodiment, at least 50 million monthly users engage the site. In certain aspects, the system further includes a health portal server 577 coupled to the general portal server 566 through the worldwide network of computers. The health portal comprises a second level of subject matter that is more specific than the first level of subject matter, the second level of subject matter being one of a plurality of health related topics. A patient aggregate server 536 couples to the health portal through the worldwide network of computers, where the patent aggregate server comprises a third level of subject matter that is more specific than the second level of subject matter.

### IV. EXAMPLE

This example illustrates a method according to the present invention related to steps involved in studying a phenotype and genotype basis for a health, disease, or other biological trait.

A client device is provided that is connected to a website of a patient aggregating server through a world wide network via a portal or a search engine or browsing or other techniques, where the server includes sub-sites defined by a phenotypic characteristic, e.g., disease, baldness, weight condition, atrophy, and the like. The user selects via an input device, one of the phenotypic characteristics, which comprises a plurality of web pages. The user is prompted by a web page directed to the phenotype characteristic comprising a branding (e.g., expert in the field, easy to use, up to date information, intelligible and useable) that has goodwill associated with the phenotype characteristic. A privacy statement is prompted to create goodwill and trust between the user and the website. Optionally, a business concept (e.g., bonus points, information, incentive award, certificate, and the like) is prompted to create further goodwill and trust between the user and the website. A registration form is optionally prompted with a plurality of fields for input from the user. The user enters information (e.g., e-mail, name, and the like) into the registration form. The user transmits information from the client device to the server. Alternatively, information is provided via fax, pager, cellular phone, mail, phone, in person, or any combination of these. The server associated with the website maintains a plurality of the user information in an aggregate form without disclosing the name of any one of the users to a third party. Once trust has been created between the user and the website, the site prompts a request for a biological sample (e.g., blood). The user fills in the request form and transfers the request form from the client to the server device. The server acknowledges receipt of request form to the client device and schedules an appointment for sampling for the user and transmits the schedule to the user. The biological sample is collected from the user and the sample information is stored with the user information directed to phenotype information. Optionally, the site provides an incentive to the user at any one of the above steps. Repeat the above steps for other users.

Thereafter, aggregate the user information directed to the phenotype information and the information contained in the biological sample (e.g., protein levels (e.g., quantification), RNA levels, DNA variations (e.g., single nucleotide polymorphisms and mutations)) in the database. It is possible to correlate using various algorithms e.g., general liner models, non-linear regressions, analysis of variance, fuzzy logic, neural networks, maximum likelihood techniques, contingency table analysis or tests, commercial algorithms and statistics the user information directed to the phenotype information with the information contained in the biological sample (e.g., protein levels, RNA level variations, DNA variations) in the database to identify trends, patterns, linkages, associations, and sub-groups, in the data.

The database can then be queried for a phenotype(s) or genotype(s) information (biological information) associated with a given phenotype(s) (or a given biological trait) or genotype(s). Determine the phenotype(s) or genotype(s) information associated with the given phenotype(s) (or a given biological trait) or genotype(s). Therefore, interpret the phenotype(s) or genotype(s) information associated with the given phenotype(s) (or a given biological trait) or genotype(s). Communicate (e.g., network, pager, mobile phone, mail, physician encounter, family member) suggestions to the user on how to act upon the interpretation. Optionally, monitor (e.g., sensors, movement, questions, requests, feedback, the user based upon the suggestion; and repeating the above steps for other phenotypes (or other biological information) or genotypes.

Through browsing activites, users are interested in providers, counselors, and testing labs. They want to know what services are provided, how they are paid for, privacy implications, and where they are located. In certain aspects, additiional databases are prepared having these additiona information sources.

In another aspect, the user interprets the genetic information in the context of a family history. These tools are valuable because they provide users a framework to work within and learn. The site's trusted intermediary status with consumers eventually allow the introduction of a robust, intelligent medical record that has a historical component.

The above steps are merely an example, which should not limit the scope of the claims herein. One of ordinary skill in the art would recognize many other variations, alternatives, and modifications.

While the above is a full description of the specific embodiments, various modifications, alternative constructions and equivalents may be used. Therefore, the above description and illustrations should not be taken as limiting the scope of the present invention which is defined by the appended claims.

What is claimed is:

1. A method for aggregating persons with a select profile for further medical studies, the method comprising:
browsing one or more selected electronic sites directed to medical information by a user of a selected profile at a client location, which is coupled to a worldwide area network of computers comprising the Internet;
profiling said user for a selected area of medicine through the browsing activities at a server location that is coupled to the worldwide area network of computers;
inquiring about specific information from said user at the client through one or more inquiries from the server;
inputting information about the specific information from said client that is transferred to said server location;
delivering additional information on said selected area of medicine from the server location to said client; and
repeating any two of the above steps to develop a relationship with the user, thereby aggregating persons with said select profile for further medical studies.

2. The method of claim 1, further comprising inquiring for genetic material directed to the selected profile.

3. The method of claim 2, further comprising analyzing the genetic material directed to the selected profile.

4. The method of claim 1, further comprising repeating the steps to form a community of users with the medical profile.

5. The method of claim 4, wherein the community of users with the medical profile is private.

6. The method of claim 5, developing treatments for the community.

7. The method of claim 6, wherein the community is for heart disease.

8. The method of claim 1, wherein the worldwide network of computers comprises the Internet.

9. The method of claim 1, wherein the information is phenotype information.

10. A system for aggregating persons with a select profile for further medical studies, the system comprising:
a general portal server coupled to a worldwide network of computers, the portal server comprising a first level of subject matter from a plurality of subject matter topics and at least 50 million monthly users;
a health portal server coupled to the general portal server through the worldwide network of computers, the health portal comprising a second level of subject matter that is more specific than the first level of subject matter, the second level of subject matter being one of a plurality of health related topics; and
a patient aggregate server coupled to the health portal through the worldwide network of computers, the patent aggregate server comprising a third level of subject matter that is more specific than the second level of subject matter.

11. The system of claim 10, wherein the patient aggregate server comprises first patient information from the general portal server.

12. The system of claim 10, wherein the patient aggregate server comprises first patient information from the health portal server.

13. The system of claim 10, wherein the patient aggregate server comprises patient information.

14. The system of claim 10, wherein the patient aggregate server comprises patient information, the patent information comprises phenotype information and genotype information.

15. A method for gathering patients from more than one servers for aggregating a select group of patients, the method comprising:
providing a general portal server coupled to a worldwide network of computers, the portal server comprising a first level of subject matter from a plurality of subject matter topics and a multitude of monthly users;
providing universal user registration information to the general sever of a user, the user registration information being stored in the general server;
entering a health aggregate server through the general portion server; and
sharing selected portions of the universal user registration information to the health aggregate server based a predetermined selection of information.

16. The method of claim 15, wherein the sharing is transparent to the user.

17. The method of claim 15, wherein the selected portion of the user information is encrypted for security.

18. The method of claim 15, wherein the entering is provided through a link or a button.

19. The method of claim 15, wherein a credit is provided to the general server portion by a number of impressions, a number of click through, or location of entry on the web page.

20. The method of claim 15, wherein said multitude of monthly users is at least 50 million.
